(19) United States
(12) Patent Application Publication
(10) Pub. No.: US 2026/0235718 A1
(43) Pub. Date: Aug. 13, 2026

(54) METHODS, ARCHITECTURES, APPARATUSES AND SYSTEMS FOR DEVICE POSITIONING BASED ON MACHINE LEARNING

(71) Applicant: InterDigital Patent Holdings, Inc., Wilmington, DE (US)

(72) Inventors: Kunjan SHAH, London (GB); Fumihiro HASEGAWA, Westmount (CA); Yugeswar Deenoo NARAYANAN THANGARAJ, Chalfont, PA (US); Moon-il LEE, Melville, NY (US); Paul MARINIER, Brossard (CA); Frank LASITA, Long Beach, NY (US)

(21) Appl. No.: 19/155,802

(22) PCT Filed: Feb. 14, 2024
(86) PCT No.: PCT/US2024/015794

§ 371 Date: Aug. 12, 2025

Related U.S. Application Data
(60) Provisional application No. 63/445,511, filed on Feb. 14, 2023.

(51) Int. Cl. G01S 5/14; G01S 5/02; H04W 64/00

(52) U.S. Cl. CPC G01S 5/14; G01S 5/0244; H04W 64/00

(57) ABSTRACT

Procedures, methods, architectures, apparatuses, systems, devices, and computer program products for measurement for positioning of a wireless transmit/receive unit, WTRU. The WTRU obtains at least one measurement value based on a plurality of measurements on a plurality of reference signals received from a plurality of transmission points, the at least one measurement value respectively indicative of relative time differences between reception of a reference signal received from a given transmission point and a reference signal received from a reference transmission point; determines respective values indicative of confidence for the plurality of transmission points; obtains from the at least one measurement value and the values indicative of confidence, an estimated range of relative time differences; determines at least one measurement value that falls within the obtained range of values; and transmits, to a network, the estimated range of relative time differences and the at least one determined measurement value.

### CROSS-REFERENCE TO RELATED APPLICATION

This application claims the benefit of U.S. Provisional Application No. 63/445,511, filed 14 Feb. 2023, which is incorporated herein by reference in its entirety.

### BACKGROUND

The present disclosure is generally directed to the fields of communications, software and encoding, including, for example, to methods, architectures, apparatuses, systems directed to device positioning.

### SUMMARY

In a first aspect, the present principles are directed to a method at a wireless transmit/receive unit, comprising obtaining at least one measurement value based on a plurality of measurements on a plurality of reference signals received from a plurality of transmission points, the at least one measurement value respectively indicative of relative time differences between reception of a reference signal received from a given transmission point and a reference signal received from a reference transmission point, determining respective values indicative of confidence for the plurality of transmission points, obtaining from the at least one measurement value and the values indicative of confidence, an estimated range of relative time differences, determining at least one measurement value that falls within the obtained range of values, and transmitting, to a network, the estimated range of relative time differences and the at least one determined measurement value.

In a second aspect, the present principles are directed to a wireless transmit/receive unit comprising memory coupled to at least one hardware processor configured to obtain at least one measurement value based on a plurality of measurements on a plurality of reference signals received from a plurality of transmission points, the at least one measurement value respectively indicative of relative time differences between reception of a reference signal received from a given transmission point and a reference signal received from a reference transmission point, determine respective values indicative of confidence for the plurality of transmission points, obtain from the at least one measurement value and the values indicative of confidence, an estimated range of relative time differences, determine at least one measurement value that falls within the obtained range of values, and transmit, to a network, the estimated range of relative time differences and the at least one determined measurement value.

In a third aspect, the present principles are directed to a non-transitory computer-readable storage medium storing instructions that, when executed, cause at least one hardware processor perform the method of any embodiment of the first aspect.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 illustrates an example of a neural network;

FIG. 3 illustrates confidence indicator prediction for timing measurement according to an embodiment of the present principles;

FIG. 4 illustrates training of an artificial intelligence/machine learning (AI/ML) model to generate a hard confidence indicator according to an embodiment of the present principles;

FIG. 5 illustrates training of an AI/ML model to generate a soft confidence indicator according to an embodiment of the present principles;

FIG. 6 illustrates an example of inference of an AI/ML model to predict confidence indicator according to an embodiment;

FIG. 7 illustrates a WTRU able to measure more than three timing measurement values from three different transmission reception points (TRPs);

FIG. 8 illustrates confidence indicator-based rejection of time domain outlier measurement according to an embodiment;

FIG. 9 illustrates confidence indicator threshold-based rejection of outlier measurements according to an embodiment; and

FIG. 10 illustrates confidence indicator threshold-based rejection of outlier measurements according to an embodiment.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

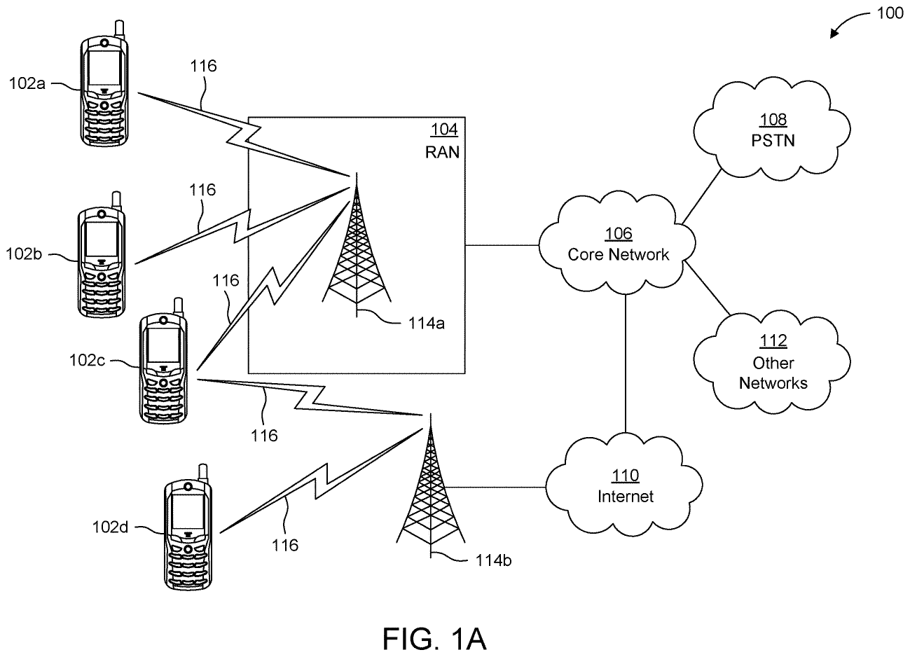

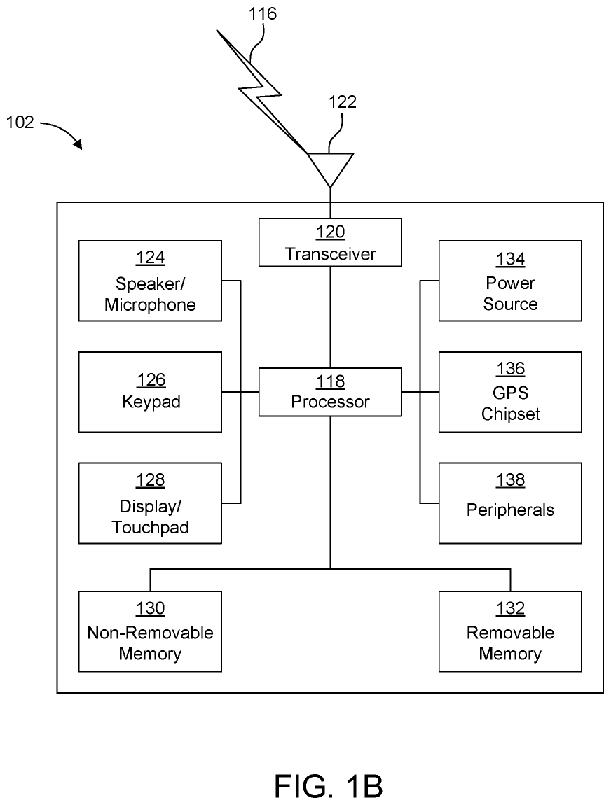

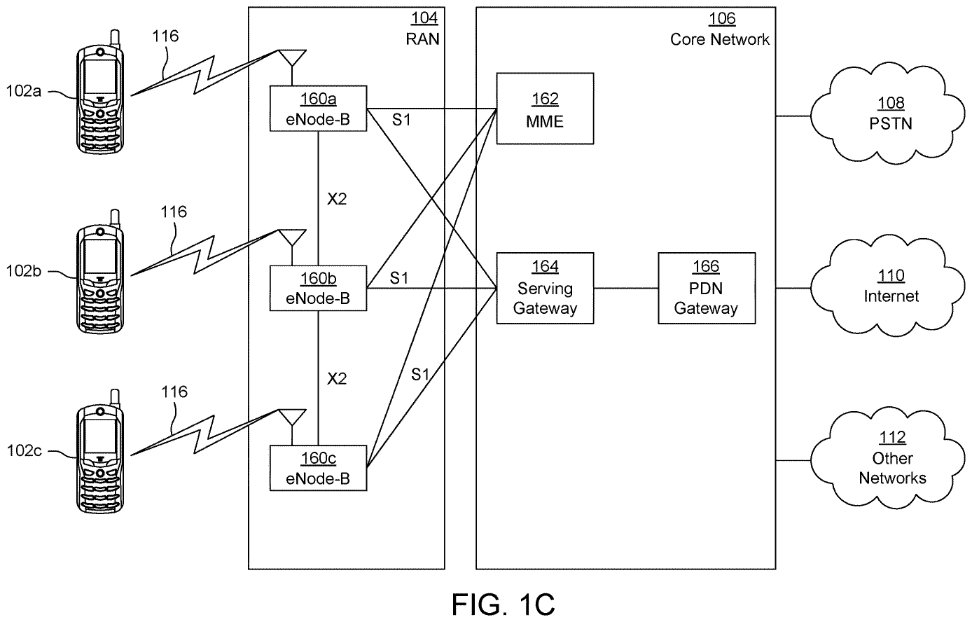

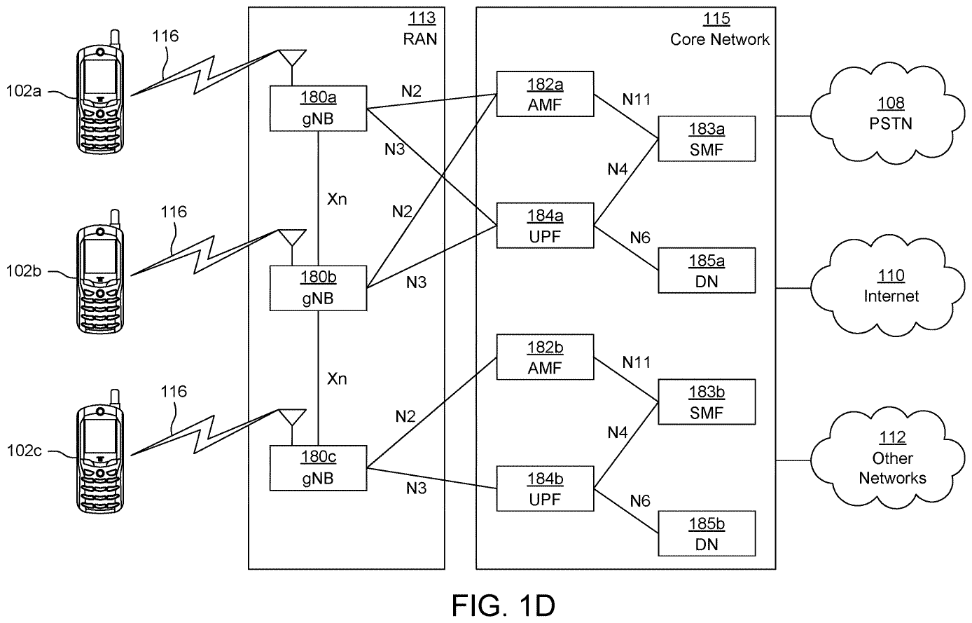

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network. In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

As used herein, a “network” may include one or more of AMF, LMF, gNB or NG-RAN (or nodes with similar functionality).

Further, “pre-configuration” and “configuration” may be used interchangeably, “non-serving gNB” and “neighboring gNB” may be used interchangeably, “gNB” and “TRP” may be used interchangeably, “PRS”, “SRS”, “SRS for positioning” and “SRS for positioning purpose” may be used interchangeably, “PRS” and “PRS resource” may be used interchangeably, “PRS(s)” and “PRS resource(s)” may be used interchangeably. The “PRS(s)” and “PRS resource(s)” may belong to different PRS resource sets. Further, “PRS,” “DL-PRS” and “DL PRS” may be used interchangeably, as may “measurement gap” and “measurement gap pattern”. “Measurement gap pattern” may include parameters such as measurement gap duration or measurement gap repetition period or measurement gap periodicity. Further, “event” and “occasion” may be used interchangeably.

In addition, “prediction” and “determination” may be used interchangeably, as can “predicting” and “determining,” and “predict” and “determine”.

Herein, the expressions “ideal” is not meant to express perfection; rather, it expresses more favorable conditions (e.g., line-of-sight conditions) compared to less favorable condition (e.g., non-line-of-sight conditions).

Artificial intelligence, AI, may be broadly defined as the behavior exhibited by machines that mimics cognitive functions to sense, reason, adapt and act.

One field of AI is machine learning, ML, that may refer to types of algorithms that solve a problem based on learning through experience (‘data’), without explicitly being programmed (‘configuring set of rules’). Different machine learning paradigms may be envisioned based on the nature of data or feedback available to the learning algorithm. For example, supervised learning may involve learning a function that maps input to an output based on labeled training example, wherein each training example may be a pair consisting of input and the corresponding output. For example, unsupervised learning may involve detecting patterns in the data with no pre-existing labels. For example, reinforcement learning may involve performing a sequence of actions in an environment to maximize the cumulative reward. In some solutions, it is possible to apply machine learning algorithms using a combination or interpolation of the mentioned approaches. For example, semi-supervised learning may use a combination of a small amount of labeled data with a large amount of unlabeled data during training. In this regard semi-supervised learning falls between unsupervised learning (with no labeled training data) and supervised learning (with only labeled training data).

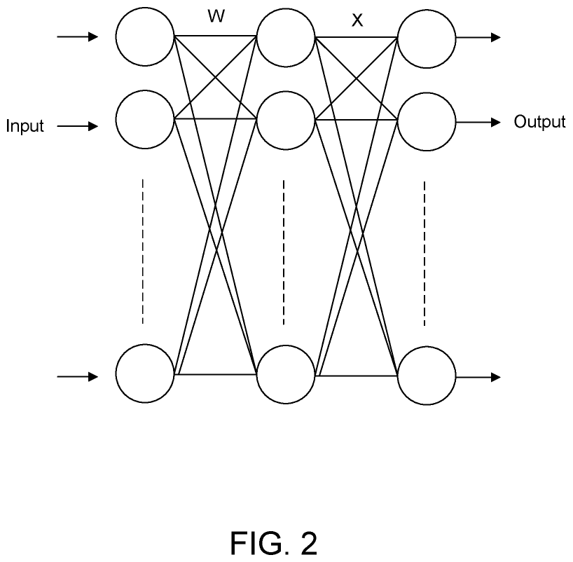

A ML algorithm may be implemented in an artificial neural network (often simply called neural network). FIG. 2 illustrates an example of a neural network. When training a neural network, the objective is to apply input and adjust weights, indicated by w and x in FIG. 2, (which may be referred to as neuron weights or link weights), such that the output from the neural network approaches the desired target values that are associated with the input values. In the example in FIG. 2, the neural network consists of three layers. During the training, for a given input, the difference between output and desired values is computed and the difference is used to update the weights in the neural network. If a large difference between output and desired values is observed, large changes in weights are expected while small difference typically leads to small changes in weights.

For example, for positioning, the input can be reference signal parameters and the output can be the estimated position. The desired value can be location information acquired by global navigation satellite system (GNSS) with high accuracy.

Once the neural network is trained (e.g., when the difference between the output and desired values is below a threshold), it can be applied for positioning by feeding input to it and using the output as the expected outcome for the associated input. The output may be the estimated position or location of the UE.

Thus, for training a neural network it can be important to identify input for the neural network, expected output associated with the input, and actual output from the neural network against which the target values are compared.

As an example, a neural network model can be characterized by its number of weights and its number of layers.

Deep learning refers to a class of machine learning algorithms that employ artificial neural networks (specifically deep neural networks (DNNs)) and include at least one hidden layer. The DNNs are a special class of machine learning models inspired by the human brain wherein the input is linearly transformed and passes through non-linear activation functions multiple times. DNNs typically consist of multiple layers where each layer may consist of a linear transformation and a plurality of activation functions (e.g., non-linear activation functions). The DNNs can be trained using the training data via a back-propagation algorithm. Recently, DNNs have shown state-of-the-art performance in a variety of domains, e.g., speech, vision, and natural language, and for various machine learning settings supervised, un-supervised, and semi-supervised.

Classification refers to the class of machine learning algorithms that predicts discrete target variable(s). Some applications of classification problems are spam filtering for email, image classification and fraud detection. Training data is labelled with one of the predefined categories (e.g., spam or not spam for email for an example of spam filtering) before inputting to classification models.

Examples of classification models include logistic regression, decision tree, random forest, and naive Bayes.

For example, in spam filtering, when determining output, a classification model inputs predefined data (e.g., email) and predicts its label (e.g., spam or not spam).

3GPP Rel. 16 provides downlink (DL), uplink (UL), and downlink and uplink positioning methods.

A “DL positioning method” may refer to any positioning method that uses downlink reference signals such as Positioning Reference Signal (PRS). The UE receives multiple reference signals from Transmission Point(s) (TP(s)) and measures DL Reference Signal Time Difference (RSTD) and/or Reference Signal Received Power (RSRP). Examples of DL positioning methods are Downlink Angle of Departure (DL-AoD) or Downlink Time Difference of Arrival (DL-TDOA) positioning.

A “UL positioning method” may refer to any positioning method that uses uplink reference signals such as Sounding Reference Signal (SRS) for positioning. The UE transmits SRS to multiple Reception Points (RPs) and the RPs measure the UL Relative Time of Arrival (RTOA) and/or RSRP. Examples of UL positioning methods are UL-TDOA or Uplink Angle of Arrival (UL-AoA) positioning.

A “DL & UL positioning method” may refer to any positioning method that uses both uplink and downlink reference signals for positioning. In one example, a UE transmits SRS to multiple transmission reception point(s) (TRPs) and gNB measures Rx-Tx time difference which is calculated based on the time of arrival of DL reference signal (RS) (e.g., PRS). The gNB can measure RSRP for the received SRS. The UE measures Rx-Tx time difference for PRS transmitted from multiple TRPs. The UE can measure RSRP for the received PRS. The Rx-TX difference and possibly RSRP measured at UE and gNB are used to compute round trip time. Here “UE Rx-Tx time difference” refers to the difference between arrival time of the reference signal transmitted by the TRP and transmission time of the reference signal transmitted from the UE. An example of DL & UL positioning method is multi-RTT (round-trip time) positioning.

In one example, a PRS configuration may contain at least one of the following parameters: number of symbols, transmission power, number of PRS resources included in PRS resource set, muting pattern for PRS (for example, the muting pattern may be expressed via a bitmap), periodicity, type of PRS (e.g., periodic, semi-persistent, or aperiodic), slot offset for periodic transmission for PRS, vertical shift of PRS pattern in the frequency domain, time gap during repetition, repetition factor, RE (resource element) offset, comb pattern, comb size, spatial relation, QCL information (e.g., QCL target, QCL source) for PRS, number of PRUs, number of TRPs, Absolute Radio-Frequency Channel Number (ARFCN), subcarrier spacing, expected RSTD, uncertainty in expected RSTD, start physical resource block (PRB), bandwidth, BWP ID, number of frequency layers, start/end time for PRS transmission, on/off indicator for PRS, TRP ID, PRS ID, cell ID, global cell ID, PRU ID, and applicable time window. The UE may apply a PRS configuration under a condition that the current time is within the applicable time window.

In one example, SRS for positioning (SRSp) or SRS configuration may include at least one of: resource ID, comb offset values, cyclic shift values, start position in the frequency domain, number of SRSp symbols, shift in the frequency domain for SRSp, frequency hopping pattern, type of SRSp (e.g., aperiodic, semi-persistent or periodic), sequence ID used to generate SRSp, or other IDs used to generate SRSp sequence, spatial relation information, indicating which reference signal (e.g., DL RS, UL RS, CSI-RS, SRS, DM-RS) or SSB (e.g., SSB ID, cell ID of the SSB) the SRSp is related to spatially where the SRSp and DL RS may be aligned spatially, QCL information (e.g., a QCL relationship between SRSp and other reference signals or SSB), QCL type (e.g., QCL type A, QCL type B, QCL type D), resource set ID, list of SRSp resources in the resource set, transmission power related information, pathloss reference information which may contain index for SSB, CSI-RS or PRS, periodicity of SRSp transmission, and/or spatial information such as spatial direction information of SRSp transmission (e.g., beam information, angles of transmission), spatial direction information of DL RS reception (e.g., beam ID used to receive DL RS, angle of arrival).

Rel. 17 provides downlink, uplink and downlink and uplink positioning methods for positioning. The UE or network may derive positioning measurements (e.g., RSRP, RSTD, AoA, AoD) by receiving or transmitting positioning reference signal(s) and/or sounding reference signal(s). A positioning method requires accurate positioning measurements and after processing of these measurements the UE or network may derive the UE's location information.

Positioning measurements derived by the UE or network can contain errors due to one or more error sources (e.g., Inter-TRP synchronization error, multipath propagation, NLOS environment, bandwidth of PRS or SRS), and such errors typically degrade positioning accuracy. It may be desired for the UE or network to know the accuracy of positioning measurements such that the most accurate positioning measurements are used to derive position and outlier positioning measurements are avoided.

As used herein, “measurement fingerprint” may refer to combination of measurement values of reference signals which may be transmitted from multiple TRPs, multiple beams of the same TRP or a combination of both. In one example for a UE receiving PRS from different TRPs namely TRP1, TRP2, TRP3 and TRP4, RSRP fingerprint include a per TRP RSRP Fingerprint for UE: {TRP1: −90 dbm, TRP1: −74 dbm, TRP3: −68 dbm, TRP4: −85 dbm} and a per TRP RSTD Fingerprint for UE: {RSTD21: −36.5 ns, RSTD31: 23.53 ns, RSTD41: 19.8 ns, RSTD41: −41.7 ns} (where RSTD21 is the difference of time of arrival between PRS transmitted from TRP1 and TRP2).

A “confidence indicator” associated with a measurement may refer to a quality indicator of the measurement, e.g., how similar the observed measurement is compared to an ideal measurement. A confidence indicator may be associated with any type of positioning measurement e.g., RSTD measurement, TOA measurement, RSRP measurement, RSTD fingerprint measurement, RSRP fingerprint measurement etc. A confidence indicator can be a hard value (e.g., 0 or 1) or a soft value (e.g. 0.70, 0.85).

A “conventional positioning” method may be defined by a positioning method that does not rely on a model which requires training. A conventional positioning method may require measurements (e.g., RSRP, RSTD, AoA, AoD) and the UE or network may be able to determine location information based on linear or non-linear processing of the measurements. Examples of a conventional positioning method include DL-TDOA, DL-AOD, Multi-RTT, UL-TDOA, and UL-AoA.

An “artificial intelligence/machine learning (“AI/ML″) positioning method” method may be defined by a positioning method that determines location or measurement(s) using a trained AI/ML model. The trained AI/ML model may for example use one or more of the following measurements: RSRP measurement, RSTD measurement, RSRP fingerprint and RSTD fingerprint. The process of determining the output of the AI/ML model may be referred as “inference” or “estimation”.

According to the present principles, the UE may input measurement(s) (e.g., RSRP and/or RSTD) to an AI/ML model and predict a confidence indicator of measurement(s). Based on a predefined confidence indicator threshold configured by the network, the UE may reject measurement(s) whose confidence indicator is below the threshold and use remaining measurement(s) in a positioning method (e.g., DL-TDOA) to obtain an estimate of its location.

By determining the confidence indicator of measurement(s) using a trained AI/ML model, the UE may select the most accurate positioning measurements to obtain its location and reject outlier measurements.

The UE may be preconfigured to collect multiple measurement samples from the same source measured at different time instances. A UE can be configured to use a ML model to predict a confidence indicator (output of the model) associated with positioning measurement (by providing positioning measurements as input to the ML model). Possible sets of inputs include UE RSRP measurements, UE RSTD measurements, sensor data, image/video data, and/or output of positioning method(s). A confidence indicator can be associated with either a measurement from single PRS (e.g., RSRP, RSRQ, RSTD, TOA etc. . . . ) or a fingerprint of a measurement (e.g., unique sequence of measurement observed from multiple PRS sources). A confidence indicator can be a hard value (e.g., 0 or 1) or a soft value (e.g., 0.70, 0.85). In one example, the confidence indicator may be defined in a range where the range is indicated by the minimum and maximum value of the confidence indicator. For example, the range of the soft confidence indicator can be [0, 1] and the soft indicator may be between 0 and 1 with a predefined granularity (e.g., 0.1 such that the confidence indicator is 0, 0.1, 0.2, . . . , 1). The UE predicts confidence indicator associated with each measurement sample.

In some embodiments, timing measurements are unique per geographical locations and UEs in the same location (e.g., within a threshold distance from each other) obtain similar (ideal) timing measurements. During the training phase, the UE may move throughout the entire deployment area to learn RSRP fingerprint and timing measurement(s). The labelled timing measurements may be both ideal (e.g., measured in LOS condition, measured, large PRS bandwidth, etc.) and non-ideal (e.g., measured in NLOS condition, short PRS bandwidth etc.). The confidence indicator associated with timing measurement may indicate error associated with the measurement. During the inference phase, the UE may input a RSRP fingerprint and timing measurement(s) as input and estimate a confidence indicator of the timing measurement.

Based on a preconfigured threshold for the confidence indicator, the UE may reject outlier measurement samples and apply remaining measurements or measurements with the highest confidence indicators to the preconfigured positioning technique to obtain its position. The UE may reject an outlier measurement sample from a single PRS or measurement fingerprint. The UE may use a Radio Access Technology (RAT) dependent conventional positioning method (e.g., DL-TDOA, AoD or AoA) or a fingerprinting-based positioning method to obtain its position.

Examples of input that can be used with the ML model include RSTD per PRS resource(s), RSTD per TRP, RSTD per beam, statistical measure of RSTD (e.g., mean or variance) per PRS resource(s), maximum or minimum value of RSTD per PRS resource(s), fingerprint of RSTD, time of arrival per PRS resource, time of arrival per TRP, time of arrival per beam, statistical measure of time of arrival per PRS resource, Maximum or minimum value of time of arrival per PRS resource, and fingerprint of time of arrival per PRS resource.

Examples of ML model output include a hard confidence indicator value (e.g., 0 or 1), a soft confidence indicator value between 0 and 1 (e.g., 0.0, 0.45, 0.85 . . . , 0.99, 1.00), and a range of indicator values between preconfigured minimum and maximum values.

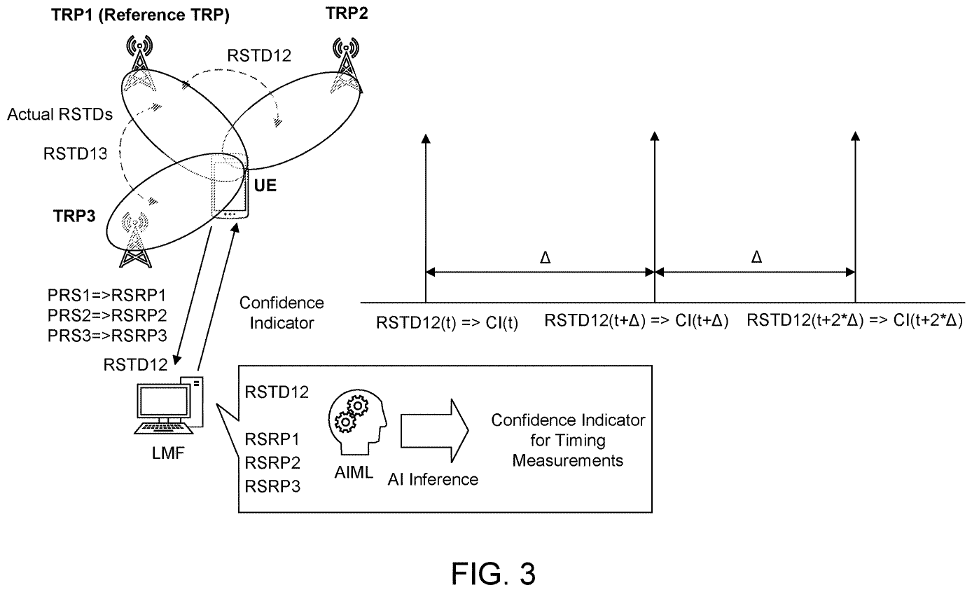

FIG. 3 illustrates confidence indicator prediction for timing measurement according to an embodiment of the present principles. A UE is configured to predict confidence indicator associated with an RSTD measurement. The UE is configured to make 3 RSTD measurement from TRP2 such that each measurement is performed separated in time by A. The UE receives PRS(s) from TRP2 at 3 different time instances RSTD12(t), RSTD12(t+Δ) and RSTD12(t+2Δ). The UE inputs each RSTD measurement to the ML model and estimates a confidence indicator (CI) associated with each measurement, namely CI(t), CI(t+Δ) and CI(t+2Δ). The UE selects the RSTD12 PRS sample with the highest CI value among CI(t), CI(t+Δ) and CI(t+2Δ), and applies a RAT-dependent conventional positioning method to obtain its position. The UE may select measurement samples from other TRPs (e.g., RSTD13) in a similar manner to obtain its position.

In some embodiments, the UE requests confidence indicator prediction after determining that the standard deviation and/or uncertainty (e.g., range of RSRP/RSTD/ToA measurements) in positioning measurement samples collected from same TRP is higher than a preconfigured threshold of standard deviation.

In some embodiments, the UE requests confidence indicator prediction after determining that measurement values are higher or lower than preconfigured values.

In some embodiments, the network may identify uncertainty in the location obtained by the UE and instruct the UE to start confidence indicator prediction for timing measurement(s).

In some embodiments, the UE stops predicting confidence indicator associated with timing measurements when positioning estimation deadline is shorter than measurement duration for making multiple measurement samples from the same PRS. In another example, the UE stops predicting confidence indicator associated with timing measurements upon receiving an indication from the network. For example, the UE may be configured to deactivate the outlier prediction and/or the UE may be configured to deactivate the AI/ML model associated with confidence prediction.

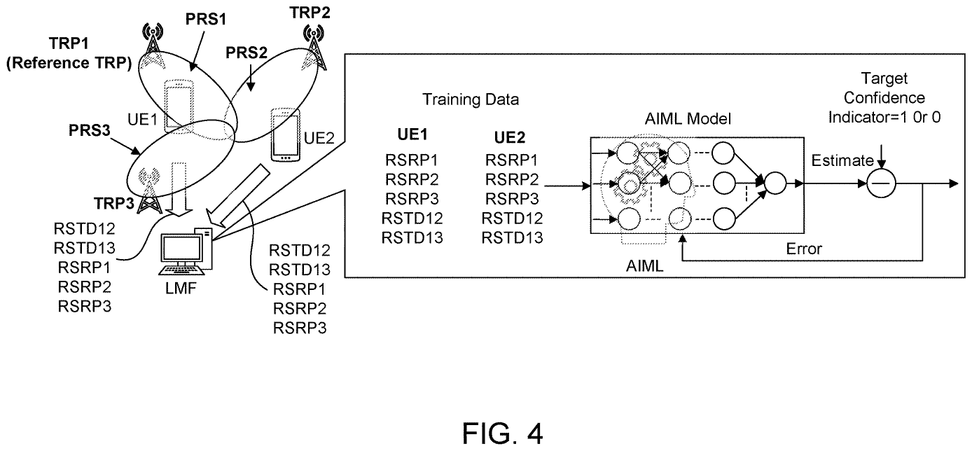

In some embodiments, the UE may indicate to the network that it is capable to train AI/ML model to predict confidence indicator for timing measurements, and it is capable to estimate/determine confidence indicator based on its capability to obtain its position (e.g., GNSS based position technique or RAT-dependent positioning technique). FIG. 4 illustrates an example of training an AI/ML model to generate a hard confidence indicator according to the present principles. The UE receives the AI/ML model (e.g., type of the model, structure of the model etc.) and information indicating the input configuration (e.g., TRPs to measure RSRP/RSTD from, sequence of RSRP/RSTD to form RSRP/RSTD fingerprint, minimum and maximum value of RSRP etc.). The UE may receive configuration information (e.g., a function where the output is the confidence indicator and input are PRS parameters) describing how to derive confidence indicator. The UE starts training AI/ML model with input measurements and confidence indicators. The UE terminates the training and returns the trained ML model to the network, for example upon obtaining a certain model training accuracy, after having input a given number of input measurements or after a given time.

The UE may determine to obtain a confidence indicator associated with timing measurement, which indicates the accuracy of timing measurements. For example, the confidence indicator may be either 0 (e.g., unreliable) or 1 (e.g., reliable). In another example, the confidence indicator may be a value between 0 and 1 such as 0.2, 0.45, 0.85 etc., where a higher value (e.g., 0.98, 1.00) of confidence indicator can indicate higher likelihood of accurate timing measurement and a lower value (e.g., 0.30, 0.15) can indicate lower likelihood of accurate timing measurements. Similarly, a higher value of confidence indicator indicates a lower likelihood of error in timing measurements and vice versa.

In some embodiments, the UE may receive geographical location points and/or relative locations compared to a reference point (e.g., the current UE location, specified location such as one of the corners in a room) from the network (e.g., LMF, gNB) to make measurements for training purposes. The user can move the UE to each location point and where it can collect training data to train an AI/ML model.

In some embodiments, the UE may receive the coordinates of a deployment area and measurement sample density from the network (e.g., 20 m radius from TRP 3 with 20 measurement samples per square meter etc.). The UE keeps training the AI/ML model until samples are collected as per the requirement of the network.

During the training phase, the UE can know its location with higher accuracy (e.g., 1-2 cm) and the network (e.g., LMF, gNB) can provide location information of TRPs with higher accuracy. The UE may use GNSS based position technique, RAT dependent positioning technique (e.g., DL-TDOA, DL-AOD) or sensor outputs (e.g., camera, RADAR, LiDAR) to determine its location. By comparing its own known location and TRP's location information, the UE may derive ideal timing measurements (e.g., RSTD, TOA etc.). In some environments (e.g., NLOS heavy environment, in presence of network synchronization error etc.), the ideal timing measurements may not be observable by the UE. By comparing timing measurements collected by the UE with the ideal timing measurements, the UE can calculate measurement errors of corresponding timing measurements. Based on a preconfigured threshold for measurement error received from the network, the UE can calculate the confidence indicator of the measurement.

In an example, the UE receives error threshold values in terms of absolute time (e.g., 2 ns) for a timing measurement (e.g., RSTD from TRP2). In this example, the UE receives PRS from TRP2, measures RSTD from TRP2 and calculates measurement error in RSTD by calculating the difference between actual RSTD value and measured RSTD value. If the calculated measurement error value is less than 2 ns, the UE can label this measurement with confidence indicator of 1 (e.g., reliable); otherwise, the UE can label this measurement with confidence indicator of 0 (e.g., unreliable).

Examples of error thresholds include absolute value of time (e.g., 2 ns), relative value of ideal timing measurement (e.g., 10% of ideal timing measurement value), standard deviation of the last (e.g., most recent) N ideal timing measurements, minimum or maximum value of absolute value of time, minimum or maximum value of measured RSRP values, minimum or maximum value of PRS bandwidth.

In an example, the UE may receive a LOS indicator associated with each TRP from the network. LOS indicator can be between 0 and 1. The higher the LOS indicator value, the higher the likelihood that corresponding measurement is accurate. The UE may label a measurement with a confidence indicator value that is the same as the LOS indicator such that all the measurements from LOS TRPs are labelled with confidence indicator of 1 and measurements from NLOS TRPs (LOS indicator value=0) are labelled with confidence indicator of 0.

In an example, the UE may receive PRS bandwidth threshold (e.g., 40 MHz) from the network such that all the timing measurements observed with PRS bandwidth shorter than the threshold PRS bandwidth are labelled with confidence indicator of 0. All the timing measurements observed with PRS bandwidth larger than threshold PRS bandwidth are labelled with confidence indicator of 1.

FIG. 4 illustrates training UEs moving in a, possibly predefined, deployment area (e.g., radius of 20 m from TRP1) and collecting RSRP fingerprint and RSTD measurements. Based on the preconfigured method (e.g., error threshold of 2 ns for RSTD), the UEs derives a confidence indicator for each collected measurements and trains the AI/ML model. After collection of a number of measurements above a threshold of number of measurements, a UE can terminate training and return the trained AI/ML model along with weights to the network.

A UE may for example use one or more of the following types of AI/ML classification model to classify timing measurements and map it to hard confidence indicator value (e.g., 0 or 1): Logistic Regression, Support Vector Machine, K-Nearest Neighbour, Random Forest, Decision Tree, Naive Bayes, CNNs (Convolutional Neural Networks) and ResNets (Residual Neural Networks). It should be noted that these are just examples, the UE may use any type of suitable AI/ML algorithm and/or architecture.

In an exemplary embodiment, to train an AI/ML model using a (hard) confidence indicator, the UE determines the method to derive its location (e.g., UE-based RAT-dependent methods, GNSS, Wi-Fi) based on availability/UE capability. In case the UE has an available method to determine a confidence indicator associated with each measurement (e.g., by obtaining ideal measurement from UE position and comparing ideal measurement with measurements observed by the UE), the UE can indicate to the network that the UE can train AI/ML model. From the network, the UE receives an AI/ML model to train, information indicating how to associate confidence indicators with measurements (e.g., based on absolute error value) and thresholds to label a measurement (e.g., confidence indicator of 1 if absolute error value <2 ns). The UE receives a PRS configuration from the network. The UE obtains measurements (e.g., RSRP, TDOA, TOA) from PRS(s) received and obtains a hard confidence indicator (0 or 1) associated with measurement. The UE trains the AI/ML model with the measurements and the confidence indicators. The UE returns weights for the trained AI/ML model to the network.

In some implementations, the UE may be able to derive soft confidence indicator (e.g., 0.95, 0.55, 0.3 etc. . . . ) of the timing measurement. A soft confidence indicator value can indicate the likelihood of error in the measurement with finer granularity than hard confidence indicator. Such fine representation of confidence indicator can allow the UE to select marginally more accurate timing measurements over marginally less accurate timing measurements. A soft confidence indicator can show impact measurement errors from multiple sources (e.g., NLOS path measurements, network synchronization error) as a single indicator.

In one example, after indicating capability to derive soft confidence indicator to the network the UE receives maximum error value (e.g. 10 ns) from the network for corresponding PRS resource. To calculate soft confidence indicator, the UE first drives measurement error in timing measurement by calculating difference between ideal timing measurement and observed timing measurements. In next step, the UE calculates soft confidence indicator, for example using following equation:

$$Confidence Indicator = 1 - ( \frac{measurement error}{maximum error} )$$

As per this equation, for a maximum error value of 10 ns, a measurement error of Ins translates to confidence indicator value of 0.9 and a measurement error of 8 ns translates to confidence indicator value of 0.2. In another example, when the UE receives a maximum error value of 2 ns, a measurement error of 1 ns translates to confidence indicator of 0.5.

The UE may for example use any of the following functions to calculate the confidence indicator: a linear function, a quadratic function, a higher order polynomial function, a hyperbolic function, an exponential function, a ceiling function and a floor function. The UE may use any suitable AI/ML algorithm, architecture, model and/or algorithm to determine the confidence indicator.

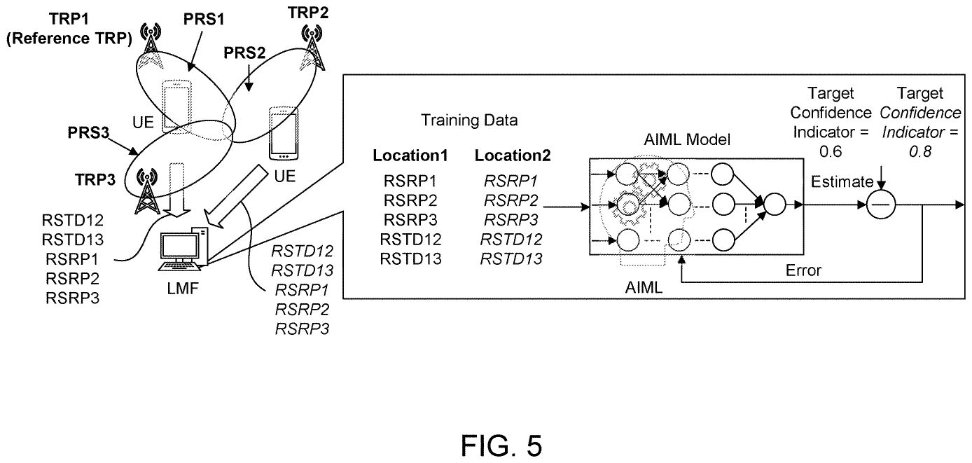

FIG. 5 illustrates an example of training an AI/ML model to generate a soft confidence indicator according to the present principles. The UE moves in a predefined deployment area (e.g., defined by Cartesian coordinates or trajectory information) collects RSRP and RSTD measurements. Measurements and confidence indicator associated with location 1 are shown in bold (purple) text while measurements and confidence indicator associated with location 2 are shown in italic (red) text. The UE first calculates measurement errors by calculating differences between collected measurements and ideal measurements and then calculates soft confidence indicators (e.g., soft confidence indicator=0.75) from measurement error and a preconfigured method (e.g., maximum measurement error is equal to 40% of ideal measurement value). The UE collects timing measurement samples both from multiple non-ideal conditions (e.g., NLOS heavy environment, network synchronization errors, shorter PRS bandwidth etc.) and ideal conditions (e.g., LOS with TRPs, larger PRS bandwidth) such that standard deviation of sample size remains constant across the range of confidence indicator.

In another example, the UE estimates a confidence indicator of each RSTD measurement and calculates a confidence indicator of RSTD fingerprint by calculating the mean value of each RSTD measurement value.

The UE may use one or more of the following example functions to calculate confidence indicator of RSTD fingerprint from confidence indicator of an RSTD measurement: statistic operation of confidence indicator values (e.g., mean, median etc.), minimum value of confidence indicator values of RSTD measurements, and maximum value of confidence indicator values of RSTD measurements.

In an example embodiment, the UE trains the AI/ML model using a soft confidence indicator. The UE determines the method to derive its location (e.g., UE-based RAT dependent methods, GNSS, Wi-Fi) based on availability/UE capability. In case the UE has an available method to determine confidence indicators respectively associated with the RSTD fingerprints (e.g., by obtaining ideal measurement from UE position and comparing ideal measurement with measurements observed by the UE), the UE indicates to the network that the UE can train the AI/ML model. From the network, the UE receives an AI/ML model to train, maximum error value to calculate confidence indicator(s) for timing measurement(s). The UE receives PRS configuration from the network. The UE obtains measurements (e.g., RSRP, TDOA) from received PRS(s) and obtains confidence indicators (by calculating ideal timing measurements from known UE location) associated with each RSTD fingerprint measurement. The UE trains the AI/ML model with RSTD fingerprints and confidence indicators. The UE returns weights for the trained AI/ML model to the network.

In embodiments of the present principles, the UE may input RSRP and timing measurements to an AI/ML model and predict confidence indicators of timing measurement(s). Based on a predefined confidence indicator threshold configured by the network, the UE may reject measurement(s) whose confidence indicator is below the threshold and use remaining measurement(s) as input to a positioning method (e.g., DL-TDOA) and obtain its location.

To this end, the UE can receive PRS configurations (e.g., TRP ID, PRS ID) from the network, receives confidence indicator estimation models from the network where each confidence indicator estimation model is associated with a range of soft LOS indicators, the UE is configured with a minimum number of measurements (K) for a positioning technique (e.g., DL-TDOA) from the network, the UE receives one or more PRS(s) and performs at least K+1 measurements (e.g., RSRP and RSTD) on the one or more PRS(s), determines the range of the soft LOS indicator from at least one of the at least K+1 measurements, selects a confidence indicator estimation model based on the channel condition (e.g., based on the determined LOS indicator per measurement), determines a confidence indicator for each RSTD measurement from one or more measurements (e.g., RSRP measurements and RSTD measurements) and the confidence indicator estimation model, determines the K RSTD measurements with the K highest confidence indicator values, determines its position based on the determined K RSTD measurements, and reports its location to the network.

In embodiments of the present principles, the UE may determine a measurement range (output of the AI/ML model) with certain confidence interval by applying (input to the model) measurements (e.g., RSRP fingerprint) and a confidence indicator to the trained AI/ML model. After determining the range of RSTD measurements, the UE may apply measured RSTD within the range to positioning method (e.g., DL-TDOA) and determine its position. If the measured RSTD does not lie within the determined RSTD range, the UE may apply a mean value of RSTD range as an input to the positioning technique and obtain its position.

To this end, the UE receives PRS configurations from the network, receives trained AI/ML models for each configured TRP, receives one or more PRS from one or more configured TRP and performs one or more measurements of RSTD and RSRP for one or more configured TRP, determines the confidence indicator (e.g., PRS bandwidth/reference bandwidth) for one or more configured TRP, determines the RSTD range (e.g., minimum and maximum RSTD) for one or more configured TRP, based on one or more measurements (e.g., RSRP), and/or the determined confidence indicator and/or an AI/ML model, and reports estimated RSTD range and measured RSTD value within the estimated range for one or more TRP to the network.

In some embodiments, outlier measurements can be predicted using an inference operation of an AI/ML model, as will be further described.

The UE may indicate to the network its capability of predicting confidence indicators of timing measurements based on an AI/ML model. The UE may determine the AI/ML model based on the target TRP. The UE receives a trained AI/ML model and validity conditions (e.g., TRPs to make measurement, how long the measurements are valid etc.) from the network.

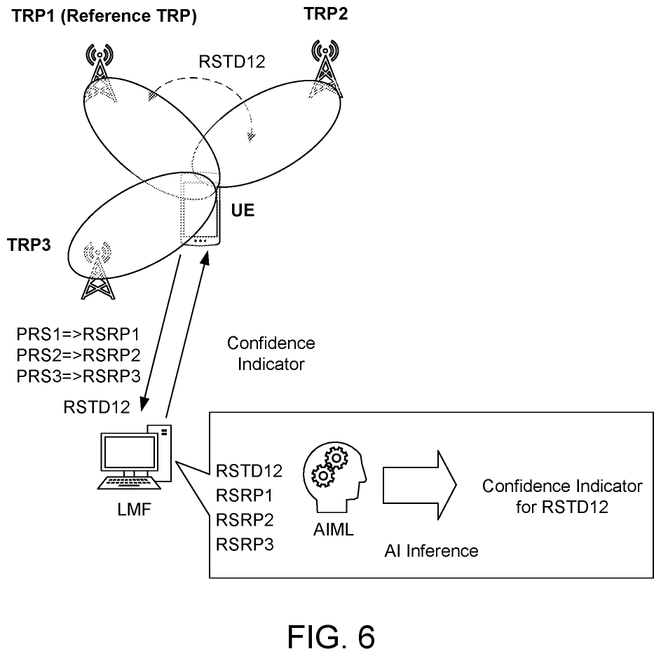

FIG. 6 illustrates an example of inference of an AI/ML model to predict confidence indicator according to an embodiment. In this example, the UE receives 3 PRSs from 3 TRPs (e.g., PRS1 from TRP1, PRS2 from TRP2, PRS3 from TRP3). The UE measures RSTD12 based on timing difference value measured between PRS2 and PRS1. Based on the highest RSRP value, the UE determines that TRP2 is the target TRP. The UE receives an AI/ML model associated with target TRP2, model inputs (RSRP1, RSRP2, RSRP3 and RSTD1) and model output (confidence indicator of RSTD12). Based on the measurements, the UE inputs RSRP1, RSRP2, RSRP3 and RSTD12 to the AI/ML model and estimates a confidence indicator value (e.g., 0.9) of RSTD12.

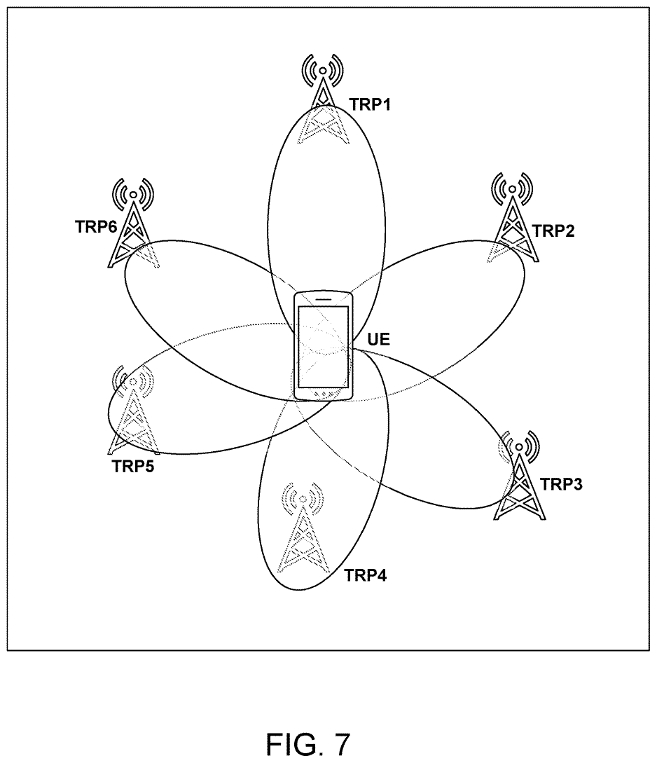

As will be described, outliers can be rejected using Top K confidence indicator. For timing-based positioning techniques (e.g., DL-TDOA), the UE requires at least three timing measurement values (e.g., RSTD) from three different TRPs. In some embodiments, the UE may be able to measure more than three timing measurement values from three different TRPs, as illustrated in FIG. 7. In this example, there are 6 different TRPs (TRP1, TRP2, TRP3, TRP4, TRP5 and TRP6) and the UE can measure 5 different RSTD values (RSTD12, RSTD13, RSTD14, RSTD15 and RSTD16) where, for example, RSTD12 is the difference of time of arrival between PRS transmitted from TRP1 and TRP2. The UE uses the trained AI/ML model and predicts respective confidence indicator values (e.g., CI_12=0.95, CI_13=0.4, CI_14=0.88, CI_15=0.62, CI_16=0.78) for the RSTD measurements. The UE can select the three RSTD measurements with the highest confidence indicator value (i.e., RSTD12, RSTD14, and RSTD16) and uses these three measurements in a DL-TDOA positioning technique to obtain its location.

In some embodiments, the UE may be configured with more than one confidence indicator estimation model, where each model may be associated with channel condition. The UE may determine the model to use in different example ways that will be described.

In a first way, each model is associated with a range of a soft LOS indicator associated with measurements (e.g., RSTD, RSRP) on PRS. The UE-determined model based on the LOS indicator using measurements made on PRS. For example, the UE may be configured with two confidence indicator estimation models where two models, model #1 and model #2 have a range of the LOS indicator with [0, 1] and [0.8, 1] where 0.8 and 1 indicate a low and a high limit of the range, respectively. The UE may make measurements on 5 PRS resources where each PRS is transmitted from a different TRP. From the measurements, the UE may determine that the range of LOS indicator is [0.8 0.9]. Based on the range of the LOS indicator, the UE can determine to use model #2 to obtain the confidence indicator.

In a second way, each model is associated with ranges of RSRP/RSTD made on PRS. For example, the UE may be configured with models with different ranges of RSRP. Based on the measurements made on PRS, the UE may determine the range of measured RSRP. Based on the determined range, the UE determines a model to use to determine the confidence indicator.

A third way is based on the granularity of the confidence indicator. For example, the UE may be configured with more than one confidence indicator estimation model, where each model is associated with a different granularity of confidence indicator (e.g., hard value such as 1 or 0 or soft value ranging from 0, 0.1, 0.2, . . . 1). Based on the accuracy requirement, the UE may determine the model. For example, for high accuracy requirement (e.g., centimeter level accuracy), the UE may determine the model with a fine granularity (e.g., soft value). In another example, the UE may base the model determination on UE capability. For example, the UE may be able to process only hard confidence indicators.

In an example embodiment, positioning uses timing measurements with top K confidence indicator values.

The UE receives PRS configurations (e.g., TRP ID, PRS ID) from the network, and receives Confidence Indicator estimation models from the network where each confidence indicator estimation model is associated with a range of soft LOS indicators. The UE is configured with a minimum number of measurements (K) for a positioning technique (e.g., DL-TDOA) from the network. The UE receives one or more PRS and performs at least K measurements (e.g., RSRP and RSTD) on the one or more PRS, determines the range of the soft LOS indicator from at least one of the at least K measurements, selects a confidence indicator estimation model, for example, based on the channel condition (e.g., based on the determined LOS indicator per measurement), determines a confidence indicator for each RSTD measurement from one or more measurements (e.g., RSRP measurements and RSTD measurements) and the confidence indicator estimation model, determines the K RSTD measurements with the K highest confidence indicator values, determines its position based on the determined K RSTD measurements, and reports its location to the network.

The UE may determine not to predict confidence indicators for all RSTD measurements. To minimize the number of AI/ML inference operations, the UE may receive additional RSRP thresholds from the network such that the UE predicts a confidence indicator of an RSTD measurement only if RSRP measurement from corresponding PRS is below the RSRP threshold. Time domain outliers may be rejected using confidence indicators.

The UE may be configured to collect more than one measurement for the same PRS resource such that each sample of measurement is collected after at least A time after collection of a previous measurement sample. In a non-ideal environment (e.g., NLOS heavy, multipath environment), the UE may be configured to receive multiple measurements from the same PRS and selects a measurement sample with the highest value of confidence indicator. The UE can select one timing measurement out of the collected N timing measurement(s) and reject outlier measurements resulting from small scale changes in channel conditions.

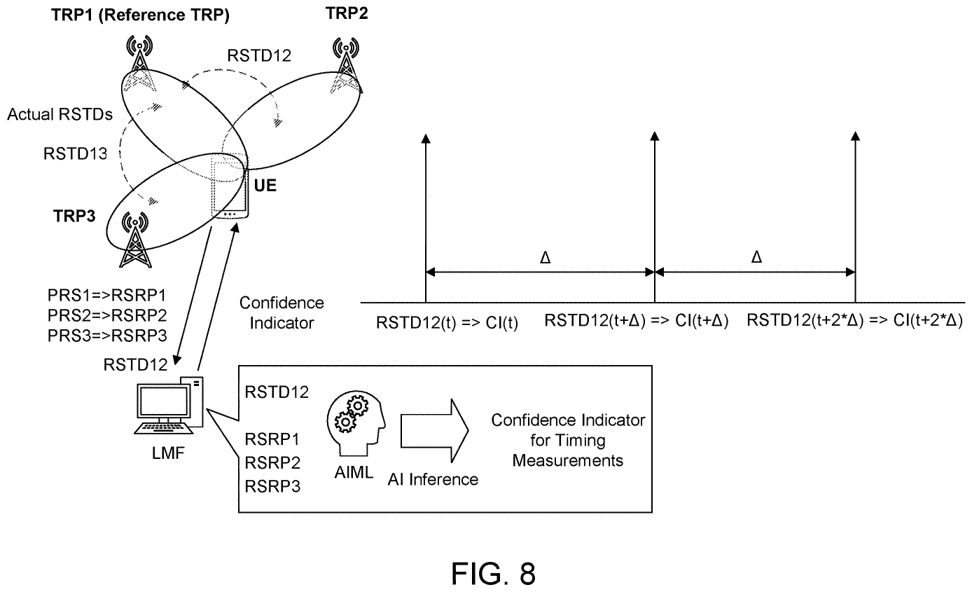

FIG. 8 illustrates confidence indicator-based rejection of time domain outlier measurement according to an embodiment. In the example in FIG. 8, a UE receives PRS1, PRS2 and PRS3 from TRP1, TRP2 and TRP3, respectively. The UE is configured with an AI/ML model to predict confidence indicator of RSTD12, 3 measurements samples (N=3) to collect for RSTD12 and a time gap between consecutive samples (Δ=1 ms). The UE receives information for PRS configuration from the network. The UE makes the RSRP measurements and obtains N (i.e., 3) samples for RSTD12. The UE inputs a RSRP fingerprint and N samples of RSTD12 to the AI/ML model and predicts N confidence indicator values. The UE selects the RSTD measurement with the highest confidence indicator value and uses this measurement to obtain its location using a preconfigured positioning method (e.g., DL-TDOA).

In an example embodiment, time domain outlier measurement rejection uses confidence indicators.

The UE receives PRS configurations from the network, requests confidence indicator estimation model(s) corresponding to the configured TRPs from the network, receives confidence indicator estimation model(s) from the network, receives a number of measurement samples (N) and time gap between consecutive samples (Δ) for RSTD measurement from single PRS, measures the PRS, obtains RSRP and N samples of RSTD measurements, provides the obtained sample RSTD measurements (e.g., RSRP fingerprint & RSTD value) to the confidence indicator estimation model and obtains a confidence indicator for each sample RSTD measurement, selects one RSTD measurements based on the highest value of confidence indicator and rejects remaining RSTD measurement from the same PRS, uses the RSTD with the highest confidence indicator from each PRS as input to a positioning method (e.g., DL-TDOA), and obtains its position.

Outliers may be rejected using a confidence indicator threshold.

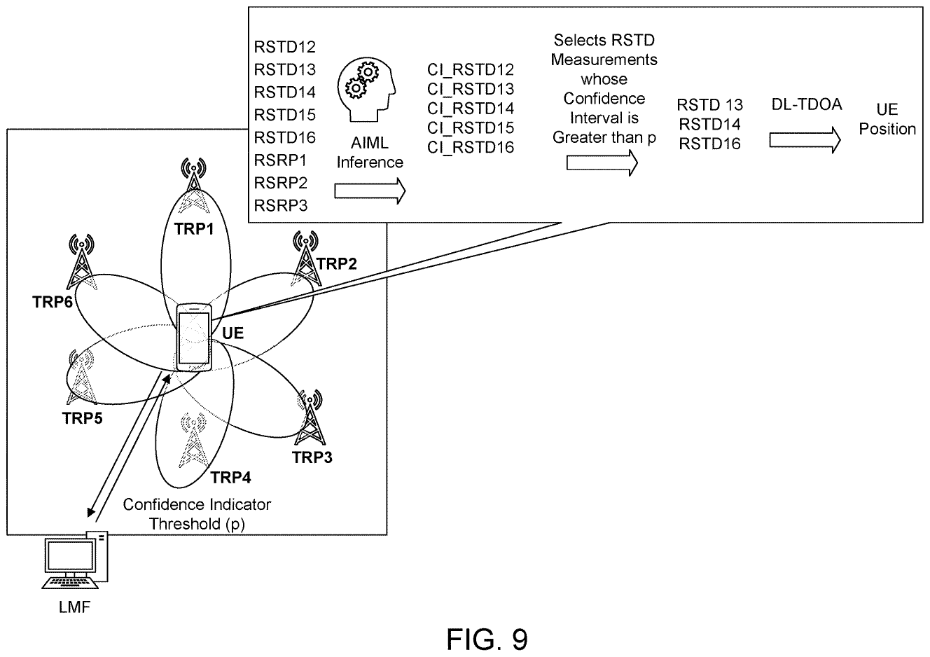

FIG. 9 illustrates confidence indicator threshold-based rejection of outlier measurements according to an embodiment.

The network may use a confidence indicator threshold (p) to assist the UE when selecting timing measurements based on preconfigured criteria and apply a positioning method to obtain its position. In one example, the preconfigured criteria to reject outlier measurements are all the measurements with a confidence indicator less than the confidence indicator threshold (p). The UE may keep requesting PRS resources until the measurements made by the UE are above the confidence indicator threshold.

The UE can indicate to the network that it is capable of predicting confidence indicators for timing measurements using an AI/ML model. The UE can receive a trained AI/ML model to predict confidence indicators and a confidence indicator threshold (e.g., p=0.8) from the network. The UE receives PRSs from TRP1, TRP2, TRP3, TRP4, TRP5 and TRP6. The UE can obtain RSRP measurements (RSRP1, RSRP2 and RSRP3) and RSTD measurements from all TRPs (RSTD12, RSTD13, RSTD14, RSTD15 and RSTD16). The UE can input the RSRP fingerprint and each RSTD (RSTD12, RSTD13 . . . . RSTD16) measurement to the trained AI/ML model and predict confidence interval values for each measurement, denoted by (and with example values) CI_RSTD12=0.72, CI_RSTD13=0.95, CI_RSTD14=0.88, CI_RSTD15=0.66 and CI_RSTD16=0.91. The UE can reject RSTD12 and RSTD15 since their confidence indicator values are below the confidence indicator threshold value of 0.8. The UE can input the remaining RSTD measurements which are above the confidence indicator threshold RSTD13, RSTD14 and RSTD16 to DL-TDOA and obtain its location.

In an example embodiment, the UE receives PRS configurations from the network, requests Confidence Indicator estimation model(s) corresponding to the configured TRPs from the network, and receives confidence indicator estimation model(s) and a confidence indicator threshold value (p) from the network. The UE can be preconfigured to collect N RSTD samples (each RSTD measurement from N different TRPs) of RSRP fingerprint & RSTD fingerprint measurements, make measurements on PRS, provide measurements (e.g., RSRP fingerprint & RSTD) to the confidence indicator estimation model, obtain confidence indicators for each RSTD measurement, input RSTD fingerprints whose confidence indicator are above the threshold into a positioning method (e.g., DL-TDOA), and obtain its position.

Outliers may be rejected using a confidence indicator for RSTD fingerprints.

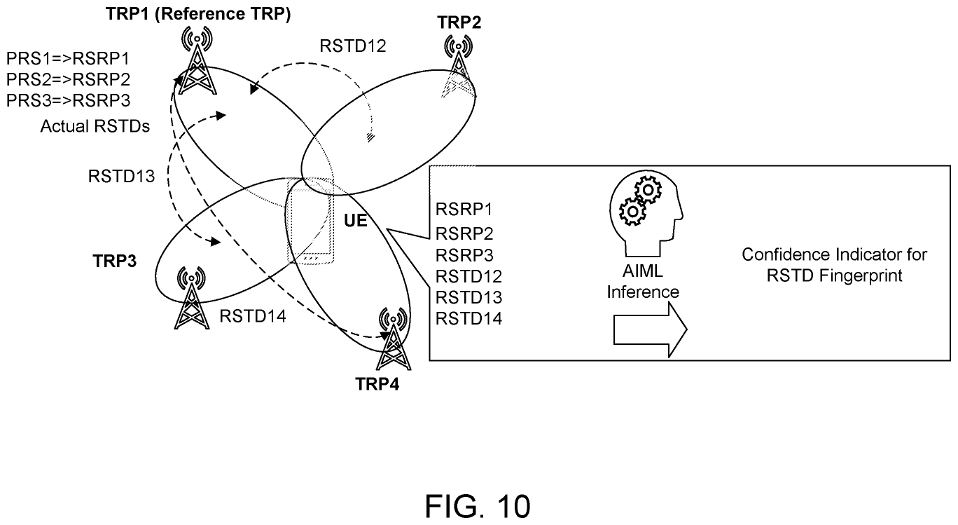

FIG. 10 illustrates confidence indicator threshold-based rejection of outlier measurements according to an embodiment.

The UE may be configured to predict a confidence indicator of a RSTD fingerprint using a trained AI/ML model. The UE can request a confidence indicator estimation model, confidence indicator threshold (p) and number (M) of RSTD measurements to collect from the network. The UE can input the RSRP fingerprint and the RSTD fingerprint samples to the AI/ML model and obtain a confidence indicator value for each RSTD fingerprint sample. The UE can reject outlier RSTD fingerprint measurements which are below confidence indicator threshold and input remaining RSTD fingerprint to positioning method (e.g., RSTD fingerprinting based positioning) to obtain its location.

In an example embodiment, the UE receives PRS configurations from the network, requests confidence indicator estimation model(s) corresponding to the configured TRPs from the network, receives confidence indicator estimation model(s) from the network, and receives a confidence indicator threshold (p) from the network. The UE can be preconfigured to collect M samples (each sample measure on a different time instance) of RSRP & RSTD fingerprint measurements. The UE makes measurements on PRS, provides the measurements (e.g., RSRP fingerprint & RSTD fingerprint) to the confidence indicator estimation model, obtains confidence indicator for each RSTD fingerprint, inputs the RSTD fingerprint(s) whose confidence indicator is above the threshold for into the positioning method (e.g., DL-TDOA, RSTD fingerprinting), and obtains its position.

In an embodiment, the UE may be configured to report to the network one or more aspects associated with the outlier rejection based on confidence indicator. In an embodiment, the report may be periodic. In an embodiment, the report may be based on preconfigured conditions. For example, the UE may be configured to report to the network one or more RSTDs (and/or the associated TRPs) whose confidence indicator is below a preconfigured threshold. For example, the UE may be configured to report to the network when the confidence indicator of more than N number of RSTDs (and/or the associated TRPs) is below a preconfigured threshold. For example, the UE may be configured to report the network when the confidence indicator of RSTD (and/or the associated TRPs) is below a preconfigured threshold more than K consecutive instances with a preconfigured time period T. The UE may be preconfigured with the values of N, K, T and the threshold by the network, possibly as a function of UE capability and/or the methods used by UE for the confidence indicator determination. In another embodiment, the UE may be configured to predict the confidence indicator of a RSTD measurement using a trained AI/ML model. The UE estimates the confidence indicator of each RSTD measurement and calculates the confidence indicator of the RSTD fingerprint by calculating the mean value of each RSTD measurement value. The UE applies the confidence indicator threshold to combined confidence indicator of RSTD measurement and does not use outlier measurement below confidence indicator threshold.

In an example embodiment, the UE may be configured to predict a confidence indicator for a range of measurements using confidence indicator estimation model. The UE receives PRS configurations from the network, requests AI/ML model(s) corresponding to the configured TRPs from the network, receives the AI/ML model(s), makes measurements on PRS, receives a confidence indicator threshold from the network, provides a range of measurements (e.g., minimum and maximum value of measured RSRP & RSTD) to confidence an Indicator estimation model (e.g., estimated distribution model for measurements), obtains confidence indicator for timing measurements, inputs timing measurements whose confidence indicator is above the threshold to a positioning method (e.g., DL-TDOA, RSTD fingerprinting), and obtains its position.

In some embodiments, measurement range can be predicted for outlier rejection, as will be further described.

A UE can be configured to use an AI/ML model to predict the range of timing measurement (output of the model) by providing RSRP measurement(s) as an input to the model. The UE may for example use one or more of the following as an input to the model: UE RSRP measurements, UE RSRP fingerprint measurement, UE RSTD measurement, UE RSTD fingerprint measurement, sensor data, and camera data. The UE may also use additional input(s) TRP ID and confidence indicator. Based on a preconfigured RSRP threshold, the UE associates itself with a TRP. A model may predict timing measurement range for RSTD per PRS resource(s), RSTD per TRP (e.g., average RSTD), RSTD per beam, time of arrival per PRS resource(s), time of arrival per TRP (e.g., average ToA), and time of arrival per beam.

The model may predict measurement range as minimum and maximum value of a timing measurement (e.g., minimum value of RSTD=1.2 ns and maximum value of RSTD=1.4 ns), mean and standard deviation of a timing measurement (e.g., mean of RSTD=1.3 ns and standard deviation of RSTD=0.2 ns), and probability distribution functions (e.g., uniform distribution).

An AI/ML model can be trained for timing measurement range prediction. Timing measurements are unique per geographical locations and UEs in the same location (e.g., within a threshold distance from each other) can obtain similar RSRP fingerprint and timing measurement(s). If the UE is training under non-ideal environmental conditions (e.g., shorter PRS bandwidth), timing measurement collected even at the same location may change between different time instances. The UE receives a confidence indicator from the network and may keep using it throughout the training procedure. In one example, the UE collects multiple timing measurement samples associated with the same location and uses minimum and maximum value of all timing measurement samples to train an AI/ML model. The UE can move throughout the entire deployment area and collect measurement samples to train the AI/ML model. After collecting predefined measurement samples for each location, the UE can return the trained AI/ML model along with the weights to the network.

In one example, the training UE collects measurements with (relatively shorter) PRS bandwidth value (e.g., 20 MHz). Due to the shorter PRS bandwidth, there is higher likelihood of measurement error in timing measurement(s) observed by this training UE. To indicate such higher likelihood of error during training, the network can configure a lower confidence indicator value (e.g., 0.5) for the UE during the training phase. When the UE collects measurements with (relatively longer) PRS bandwidth value of 100 MHz, there is a lower likelihood of measurement error in timing measurements and the network can configure a higher confidence indicator value (e.g., 0.95) for this UE during training phase.

In another example, the UE may receive functions(s) from the network regarding how to derive the confidence indicator. The UE may for example receive the following function from the network: Confidence indicator=PRS bandwidth/reference bandwidth (e.g. 100 MHz). The UE may also receive the following function: Confidence indicator=Number of LOS TRPs/reference number of LOS TRPs (e.g., 4).

Inference operation for timing measurement range prediction.

In one embodiment, the UE may be configured to determine a RSTD measurement range (e.g., minimum value and maximum value of an RSTD measurement) using a trained AI/ML model for a specific TRP. Based on a predefined RSRP threshold (e.g., measured RSRP for specific TRP above threshold value), the UE associates itself with a TRP. The UE may request an AI/ML model for timing measurement range determination for the associated TRP.

The UE receives a trained AI/ML model. In one example, the UE may receive an AI/ML model from the network per TRP/requested TRP such that the UE determines the RSTD measurement range per TRP. In another example, the UE may receive an AI/ML model that is applicable for more than one TRPs, area and/or cell. In this case, the UE may determine the RSTD measurement range for any TRPs in the area/cell the AI/ML model is associated with.

In one embodiment, the UE may determine the confidence indicator based on a function of the measurement (e.g., 1−uncertainty in TOA/TOA, 1−uncertainty in RSTD/RSTD) and/or PRS configurations (e.g., confidence indicator=PRS bandwidth/reference bandwidth, where PRS bandwidth is the bandwidth of PRS and it is smaller than the reference bandwidth). For example, the reference bandwidth can be 100 MHz. Another example can be the repetition factor of PRS. For example, the confidence indicator can be confidence indicator=repetition factor/reference repetition factor, where the repetition factor is smaller than the reference repetition factor). For example, the reference repetition factor can be the largest configurable repetition factor for PRS.

In one embodiment, if the confidence indicator (e.g., confidence indicator can be a value between 0 and 1) is low, the determined RSTD measurement range can be long, i.e., RSTD measurement range is [1 ms 100 ms], for example.

In case the confidence indicator is large, the determined RSTD measurement range can be short, i.e., RSTD measurement range is [5.5 ms 5.7 ms], for example. Thus, if the PRS bandwidth is small, ToA measurements may contain large uncertainty. Thus, the associated confidence indicator (e.g., determined by PRS_bandwidth/100 MHz, where PRS_bandwidth is smaller than 100 MHz) can be small which leads to a potentially long range for RSTD measurement. On the other hand, if the PRS bandwidth is large, ToA measurements may contain small uncertainty. Thus, the associated confidence indicator (e.g., determined by PRS_bandwidth/100 MHz, where PRS bandwidth is smaller than 100 MHz) can be large which leads to a potentially short range for RSTD measurement.

The network may indicate the value of the confidence indicator to the UE. The UE receives PRS configuration from the network and performs RSRP and RSTD measurement. The UE inputs RSRP measurements and determined confidence indicator to the AI/ML model to obtain the RSTD range.

In one example, for UE-assisted positioning methods in which the UE reports measurements to the network, in case the measured RSTD value is within the determined range of RSTD values, the UE sends measured RSTD value and range of RSTD value to the network. If the measured RSTD value is outside of the determined RSTD range the UE considers it as an outlier measurement and does not provide it to the network. Thus, if the RSTD range is long (e.g., low confidence indicator), the UE may report measurements more frequently to the network compared to the case when the RSTD range is short (e.g., high confidence indicator).

In one example, the UE may send an indicator that the UE obtained the measurement that is outside of the determined RSTD range (e.g., message such as “not available” or “NA”). The network applies RSTD measurement within predicted RSTD range to positioning method (e.g., DL-TDOA) and obtains its position.

For UE-based positioning, after determining the range of RSTD measurements, the UE may apply measured RSTD within the range to positioning method (e.g., DL-TDOA) and determine its position. In case the measured RSTD lies without the determined RSTD range, the UE can input the mean value of RSTD range to the positioning technique and obtain its position.

In an example embodiment using a confidence indicator to predict timing measurement range, the UE receives PRS configurations from the network, receives trained AI/ML models for each configured TRP, receives one or more PRS from one or more configured TRP and performs one or more measurements of RSTD and RSRP for one or more configured TRP, determines the confidence indicator (e.g., PRS bandwidth/reference bandwidth) for one or more configured TRP, determines the RSTD range (e.g., minimum and maximum RSTD) for one or more configured TRP, based on one or more measurements (e.g., RSRP), and/or the determined confidence indicator and/or an AI/ML model, and reports estimated RSTD range and measured RSTD value within the estimated range for one or more TRP to the network.

### SUMMARY

A method at a wireless transfer/receive unit (WTRU) can include obtaining a plurality of values based on measurements on at least one reference signal, obtaining, using a trained machine learning model, from the plurality of values, values to use for positioning of the WTRU, and obtaining, based on the values to use for positioning, a position of the WTRU.

The method can further include receiving from the network information indicating a configuration for the WTRU to receive the reference signals.

The method can further include receiving from the network information enabling implementation of the trained machine learning model. The method can further include transmitting to the network information indicative of a request for the information enabling implementation of the trained machine learning model.

The method can further include receiving the at least one reference signal and measuring the at least one reference signal to obtain the measurements.

The method can further include transmitting to the network information indicative of the obtained position.

At least K+1 values based on measurements can be obtained, wherein K is an integer, and obtaining from the plurality of values, values to use for positioning of the WTRU can include obtaining from the trained machine learning model a confidence value associated with each of the at least K+1 values, and selecting from the at least K+1 values the K values associated with the K highest confidence values as the values to use for positioning of the WTRU. The method can further include determining a range of line-of-sight indicator from at least one of the at least K+1 values, wherein the confidence values are obtained based on the range of line-of-sight indicator. The method can also further include obtaining from the network information indicative of the number K.

The plurality of values can be obtained based on measurements on a single reference signal at different consecutive times, and obtaining from the plurality of values, values to use for positioning of the WTRU can include obtaining from the trained machine learning model a confidence value associated with each of the plurality of values based on measurements, and selecting from plurality of values the value based on measurement associated with the highest confidence value as the value to use for positioning of the WTRU. The consecutive times can be separated by a given time interval.

Each of the plurality of values can include a set of values expressing differences between reception times of signals from distinct sets of signal sources, and obtaining from the plurality of values, values to use for positioning of the WTRU can include obtaining from the trained machine learning model a confidence value associated with each of the plurality of values, and selecting from the plurality of values, the values associated with confidence values above or equal to a given limit to use for positioning of the WTRU. The method can further include obtaining from the network information indicative of the given limit.

Obtaining from the plurality of values, values to use for positioning of the WTRU can include obtaining from the trained machine learning model a confidence value associated with each of the plurality of values based on measurements, and selecting from the plurality of values, the values associated with confidence values above or equal to a given limit to use for positioning of the WTRU. The method can further include obtaining from the network information indicative of the given limit.

Obtaining from the plurality of values, values to use for positioning of the WTRU can include obtaining from the trained machine learning model, in response to input including a range of the plurality of values based on measurements, a confidence value associated with each of the plurality of values based on measurements, and selecting from the plurality of values, the values associated with confidence values above or equal to a given limit to use for positioning of the WTRU. The method can further include obtaining from the network information indicative of the given limit.

A method at a WTRU can include obtaining at least one measurement value based on a plurality of measurements on a plurality of reference signals received from a plurality of transmission points, determining respective values indicative of confidence for the plurality of transmission points, obtaining, using a trained machine learning model, from the at least one measurement value and the values indicative of confidence, a range of a value of reference signal time difference, and transmitting, to the network, the range of the value of reference time signal and the at least one measurement value.

The method can further include receiving from the network information indicating a configuration for the WTRU to receive the reference signals.

The method can further include receiving from the network information enabling implementation of the trained machine learning model. The method can further include transmitting to the network information indicative of a request for the information enabling implementation of the trained machine learning model.

The method can further include receiving the at least one reference signal, and measuring the at least one reference signal to obtain the at least one measurement value.

The at least one measurement value can express measured reference signal time difference. The range can express minimum and maximum measured reference signal time differences.

A method at a WTRU can include in case the WTRU is capable of determining confidence values associated with measurement values for WTRU location, transmitting to a network to which the WTRU is connected, information indicative of a capability to train a machine learning model, receiving, from the network, information representing the machine learning model to train, information indicative of how to associate confidence indicator with measurements and thresholds for labelling measurements, obtaining a plurality of values based on measurements on at least one reference signal, obtaining confidence values based on the plurality of values based on measurements, using the obtained confidence values to train the machine learning model, and transmitting to the network information indicative of weights of the trained machine learning model.

A method at a WTRU can include in case the WTRU is capable of determining confidence values associated with measurement values for WTRU location, transmitting to a network to which the WTRU is connected, information indicative of a capability to train a machine learning model, receiving, from the network, information representing the machine learning model to train, information indicative of a maximum error value to calculate confidence indicators for timing measurements, obtaining a plurality of values based on measurements on at least one reference signal, obtaining confidence values based on the plurality of values based on measurements, using the obtained confidence values to train the machine learning model, and transmitting to the network information indicative of weights of the trained machine learning model.

A method at a WTRU including, in case the WTRU is capable of determining confidence values associated with measurement values for WTRU location, transmitting to a network to which the WTRU is connected, information indicative of a capability to train a machine learning model, receiving, from the network, information representing the machine learning model to train, information indicative of how to associate confidence indicator with measurements and thresholds for labelling measurements, obtaining a plurality of values based on measurements on at least one reference signal, obtaining confidence values based on the plurality of values based on measurements, using the obtained confidence values to train the machine learning model, and transmitting to the network information indicative of weights of the trained machine learning model.

A method at a WTRU including, in case the WTRU is capable of determining confidence values associated with measurement values for WTRU location, transmitting to a network to which the WTRU is connected, information indicative of a capability to train a machine learning model, receiving, from the network, information representing the machine learning model to train, information indicative of a maximum error value to calculate confidence indicators for timing measurements, obtaining a plurality of values based on measurements on at least one reference signal, obtaining confidence values based on the plurality of values based on measurements, using the obtained confidence values to train the machine learning model, and transmitting to the network information indicative of weights of the trained machine learning model.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

1. A method at a wireless transmit/receive unit (WTRU), the method comprising:
obtaining at least one measurement value based on a plurality of measurements on a plurality of reference signals received from a plurality of transmission points, the at least one measurement value respectively indicative of relative time differences between reception of a reference signal received from a given transmission point and a reference signal received from a reference transmission point;
determining respective values indicative of confidence for the plurality of transmission points, wherein the values indicative of confidence are respectively determined by the WTRU based on a transmission bandwidth for a corresponding transmission point;
obtaining, from the at least one measurement value and the values indicative of confidence, an estimated range of relative time differences;
determining at least one measurement value that falls within the estimated range of relative time difference; and
transmitting, to a network, the estimated range of relative time differences and the at least one determined measurement value.

2. The method of claim 1, comprising:
receiving, from the network, information indicating a configuration for the wireless transmit/receive unit to receive the plurality of reference signals.

3. The method of claim 1, wherein the estimated range of time differences is obtained using a trained machine learning model, the method comprising:
receiving, from the network, information enabling implementation of the trained machine learning model.

4. The method of claim 3, comprising:
transmitting, to the network, information indicative of a request for the information enabling implementation of the trained machine learning model.

5. The method of claim 1, comprising:
receiving the plurality of reference signals; and
measuring the plurality of reference signals to obtain the plurality of measurements.

6. (canceled)

7. The method of claim 1, wherein the values indicative of confidence are respectively based on a reference transmission bandwidth.

8. A wireless transmit/receive unit (WTRU) configured to:
obtain at least one measurement value based on a plurality of measurements on a plurality of reference signals received from a plurality of transmission points, the at least one measurement value respectively indicative of relative time differences between reception of a reference signal received from a given transmission point and a reference signal received from a reference transmission point;
determine respective values indicative of confidence for the plurality of transmission points, wherein the values indicative of confidence are respectively determined by the WTRU based on a transmission bandwidth for a corresponding transmission point;
obtain, from the at least one measurement value and the values indicative of confidence, an estimated range of relative time differences;
determine at least one measurement value that falls within the estimated range of relative time differences; and
transmit, to a network, the estimated range of relative time differences and the at least one determined measurement value.

9. The WTRU of claim 8, configured to:
receive, from the network, information indicating a configuration for the wireless transmit/receive unit to receive the plurality of reference signals.

10. The WTRU of claim 8, wherein the estimated range of time differences is obtained using a trained machine learning model, and wherein the at least one hardware processor is configured to:
receive, from the network, information enabling implementation of the trained machine learning model.

11. The WTRU of claim 10, configured to:
transmit, to the network, information indicative of a request for the information enabling implementation of the trained machine learning model.

12. The WTRU of claim 8, configured to:
receive the plurality of reference signals; and
measure the plurality of reference signals to obtain the plurality of measurements.

13. (canceled)

14. The WTRU of claim 7, wherein the values indicative of confidence are respectively based on a reference transmission bandwidth.

15. A non-transitory computer-readable storage medium storing instructions that, when executed, cause at least one hardware processor to perform the method of claim 1.
